(19) United States
(12) Patent Application Publication
(10) Pub. No.: US 2025/0065751 A1
(43) Pub. Date: Feb. 27, 2025

(54) APPARATUS AND SYSTEM FOR MONITORING AND CONTROLLING ELECTRIC VEHICLE CHARGERS

(71) Applicant: DUKE ENERGY CORPORATION, Charlotte, NC (US)

(72) Inventors: Casey Annis, Charlotte, NC (US); Jason Clermont, Huntersville, NC (US); James Douglas Cleveland, Charlotte, NC (US); Robert Cox, Charlotte, NC (US); Tom Fenimore, Indian Land, SC (US); Steven Patrick Hinkel, Alexandria, KY (US); Bruce Hoban, Charlotte, NC (US); Chad Hoyle, Belmont, NC (US); Jay Oliver, Landrum, NC (US)

(21) Appl. No.: 18/808,223

(22) Filed: Aug. 19, 2024

Related U.S. Application Data
(60) Provisional application No. 63/578,097, filed on Aug. 22, 2023.

(51) Int. Cl. B60L 53/63; B60L 53/302; B60L 53/66; B60L 53/67; B60L 53/68; H02J 7/00

(52) U.S. Cl. CPC B60L 53/63; B60L 53/302; B60L 53/66; B60L 53/67; B60L 53/68; H02J 7/007192

(57) ABSTRACT

A Local Distributed Intelligence Node device configured to monitor and control an electric vehicle charger during a charging session of an electric vehicle includes a wireless transceiver and a control circuit. The control circuit is configured to receive a signal, via the transceiver, from a Local Circuit Supervisor device associated with an electric power grid providing electric power to the electric vehicle charger, and to throttle the amount of charge current supplied to the electric vehicle by the electric vehicle charger in response to receiving the signal.

### RELATED APPLICATION

This application claims the benefit of and priority to U.S. Provisional Patent Application No. 63/578,097 filed Aug. 22, 2023, the disclosure of which is incorporated herein by reference as if set forth in its entirety.

### FIELD OF THE INVENTION

The present invention relates generally to battery charging and, more particularly, to electric vehicle battery charging.

### BACKGROUND OF THE INVENTION

With the increasing popularity of motor vehicles that rely on electricity for some or all of their propulsion, it has become necessary to provide electrical supply capabilities that are suitable for these vehicles. Unfortunately, the electric power grid may become strained with the growing consumer demand for electricity, and the need for electric vehicle (EV) chargers is exacerbating this demand.

### SUMMARY OF THE INVENTION

It should be appreciated that this Summary is provided to introduce a selection of concepts in a simplified form, the concepts being further described below in the Detailed Description. This Summary is not intended to identify key features or essential features of this disclosure, nor is it intended to limit the scope of the invention.

Embodiments of the present invention provide an electrical load and distributed energy resource monitoring and management platform for EV charging stations comprised of hardware and software, for both private and public EV charging applications. By providing the ability to monitor EV charging stations, embodiments of the present invention can improve EV charging station operation and maintenance. Furthermore, customer trend data collected from monitoring charging sessions like average session time or kWh dispensed during specific time periods (or times of the year) provides valuable information for electric utilities and other entities to design better demand response programs in which customers will participate. Moreover, embodiments of the present invention provide the ability to identify and characterize issues with troublesome EV charging stations to better execute EV charging station preventative maintenance. In addition, with the ability to control EV charging stations based on electrical power grid loading, demand response programs leveraging EV charging stations can be deployed at lower cost and with greater reliability, ultimately offering users more options and potentially lowering charging costs during peak energy demand conditions.

According to some embodiments of the present invention, a device, also referred to as a Local Distributed Intelligence Node (LDIN) device, is configured to monitor and control an EV charger during a charging session of an EV and includes a wireless transceiver and a control circuit. The LDIN device is configured to receive a signal, via the transceiver, from a Local Circuit Supervisor (LCS) device associated with an electric power grid providing electric power to the EV charger, and to throttle (i.e., change) the amount of charge current supplied to the EV by the EV charger in response to the signal. The device may also include a power conditioning and filtering device. The LDIN device may be hardwired to the EV charger or may be wirelessly connected to the EV charger.

In some embodiments, the signal is an indication of a potential overload condition of a transformer on the electric power grid that is providing electric power to the EV charger. In this case, the control circuit is configured to reduce the amount of charge current supplied to the EV by the EV charger in order to avoid an overload condition.

In some embodiments, the signal is an indication that thermal loading of one or more components associated with the EV charger and its electrical supply equipment (e.g., a circuit breaker, a service panel, a distribution circuit, a transformer, etc.) has exceeded a threshold value. In this case, the control circuit is configured to reduce the amount of charge current supplied to the EV by the EV charger in order to avoid an overload condition.

In some embodiments, the signal is an indication that the transformer on the electric power grid that is providing electric power to the EV charger is not overloaded (i.e., has capacity). In this case, the control circuit is configured to increase the amount of charge current supplied to the EV by the EV charger or maintain the amount of charge current presently being supplied to the EV by the EV charger.

In some embodiments, the signal is an indication that there is no thermal loading of one or more components associated with the EV charger and its electrical supply equipment, such as a circuit breaker, a service panel, a distribution circuit, a transformer, etc. In this case, the control circuit is configured to increase the amount of charge current supplied to the EV by the EV charger or maintain the amount of charge current presently being supplied to the EV by the EV charger.

In some embodiments, the control circuit is configured to throttle the amount of charge current supplied to the EV by communicating with a Pilot Control signal that is being transmitted between the EV charger and the EV via a communication line.

In some embodiments, the control circuit is configured to report a real-time status of the EV charger to the LCS device via the transceiver.

In some embodiments, the transceiver is configured to communicate with an electric meter associated with the EV charger, and the control circuit is configured to collect revenue grade data from the electric meter via the transceiver.

In some embodiments, the transceiver is configured to receive information from one or more additional EV chargers in a vicinity of the LDIN device. The control circuit is configured to report a real-time status of the one or more additional EV chargers to the LCS device via the transceiver.

In some embodiments, the LDIN device control circuit is further configured to control informational lighting on or near the EV charger to indicate, for example, operational status and availability of the EV charger, such as the EV charger is available, the EV charger is charging, the EV charger is in a fault state, etc. The control circuit may also be configured to control the informational lighting on or near the EV charger to indicate that the EV charger has been reserved by a third party for future charging.

In some embodiments, the LDIN device includes a temperature sensor, and the control circuit is configured to throttle an amount of charge current supplied to the EV by the EV charger in response to a temperature of the LDIN device, as measured by the temperature sensor, exceeding a threshold temperature. The control circuit may also be configured to throttle an amount of charge current supplied to the EV by the EV charger in response to a temperature of the LDIN device, as measured by the temperature sensor, falling below a threshold temperature.

In some embodiments, the LDIN device includes a cooling system, and the control circuit is further configured to activate the cooling system in response to the temperature of the LDIN device exceeding the threshold temperature.

According to some embodiments of the present invention, a LDIN device is configured to monitor and control an EV charger during a charging session of an EV and includes a wireless transceiver and a control circuit. The control circuit is configured to receive a signal, via the transceiver, from an LCS device associated with an electric power grid providing electric power to the EV charger, and to stop an active charging session. The control circuit may also be configured to cause the EV to discharge electric power into the electric power grid via the EV charger in response to a signal including an indication of a need for electric power by the electric power grid. The device may also include a power conditioning and filtering device. The control circuit may be hardwired to the EV charger or may be wirelessly connected to the EV charger. In some embodiments, the control circuit may be configured to report a real-time status of the EV charger to the LCS device via the transceiver.

According to some embodiments of the present invention, a system configured to monitor and control an electric vehicle (EV) charger during a charging session of an EV includes a remote sensor that is configured to monitor (e.g., wirelessly monitor) at least one parameter associated with a feeder circuit providing electric power to the EV charger from an electric power grid. The system further includes a device having a transceiver and a control circuit configured to receive a signal, via the transceiver, from the remote sensor. The control circuit is configured to throttle an amount of charge current supplied to the EV by the EV charger in response to the at least one parameter exceeding an upper threshold value or falling below a lower threshold value. The control circuit may be configured to stop an active charging session and cause the EV to discharge electric power into the electric power grid via the EV charger in response to the at least one parameter.

In some embodiments, the at least one parameter may be a power load on a transformer associated with the feeder circuit. In some embodiments, the at least one parameter includes thermal loading of one or more components (e.g., a circuit breaker, a service panel, a distribution circuit, a transformer, etc.) associated with the feeder circuit.

In some embodiments, the system includes a second remote sensor that is configured to monitor temperature and/or humidity in a vicinity of the feeder circuit. The control circuit is configured to throttle the amount of electric power received by the EV battery from the charger in response to the temperature and/or humidity in the vicinity of the feeder line exceeding an upper threshold value or falling below a lower threshold value.

In some embodiments, the device is configured to communicate with an LCS device associated with the electric power grid, receive commands from the LCS device via the transceiver, and report a real-time status of the EV charger to the LCS device via the transceiver in response to such commands.

In some embodiments, the device includes a temperature sensor, and the control circuit is configured to throttle an amount of charge current supplied to the EV by the EV charger in response to a temperature of the device, as measured by the temperature sensor, exceeding a threshold temperature. The control circuit may also be configured to throttle an amount of charge current supplied to the EV by the EV charger in response to a temperature of the device, as measured by the temperature sensor, falling below a threshold temperature.

In some embodiments, the device includes a cooling system, and the control circuit is further configured to activate the cooling system in response to the temperature of the device exceeding the threshold temperature.

Embodiments of the present invention have numerous advantages. For example, an LDIN device has the ability to monitor and control EV chargers from different manufacturers. An LDIN device can autonomously vary an EV charger output based on various constraints, such as thermal operating properties of local electrical components, as well as the current load on the electric power grid. LDIN devices can be easily integrated with existing electric utility metering technology to provide revenue-grade charge session data. Moreover, LDIN devices and LCS devices can interface with smart grid management hardware and software.

It is noted that aspects of the invention described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail below.

### BRIEF DESCRIPTION OF THE DRAWINGS

The accompanying drawings, which form a part of the specification, illustrate various embodiments of the present invention. The drawings and description together serve to fully explain embodiments of the present invention.

FIG. 1 illustrates the architecture of a local distributed intelligence node (LDIN) device, according to some embodiments of the present invention.

FIGS. 2A-2B illustrate the LDIN device of FIG. 1 hardwired to an EV charger, according to some embodiments of the present invention.

FIG. 3 is an illustration of system architecture for an LDIN device utilized with a non-networked EV charger, according to some embodiments of the present invention.

FIG. 4 is an illustration of system architecture for an LDIN device utilized with a networked EV charger, according to some embodiments of the present invention.

FIGS. 5 and 6 illustrate a group of EV chargers and multiple LDIN devices in communication with the EV chargers.

FIG. 7 is a user interface displaying information for EV chargers, LDIN devices and LCS devices in a specific geographic area according to some embodiments.

### DETAILED DESCRIPTION

The present invention will now be described more fully hereinafter with reference to the accompanying figures, in which embodiments of the invention are shown. This invention may, however, be embodied in many different forms and should not be construed as limited to the embodiments set forth herein. Like numbers refer to like elements throughout. In the figures, certain components or features may be exaggerated for clarity, and broken lines illustrate optional features or operations unless specified otherwise. In addition, the sequence of operations (or steps) is not limited to the order presented in the figures and/or claims unless specifically indicated otherwise. Features described with respect to one figure or embodiment can be associated with another embodiment or figure although not specifically described or shown as such.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.,” which derives from the Latin phrase “exempli gratia,” may be used to introduce or specify a general example or examples of a previously mentioned item, and is not intended to be limiting of such item. The common abbreviation “i.e.,” which derives from the Latin phrase “id est,” may be used to specify a particular item from a more general recitation.

It will be understood that although the terms first, second, third, etc., may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

The terms “EV charging station”, “EV charger”, and EV supply equipment (EVSE), as used herein, are interchangeable and refer to any equipment that connects an electric vehicle (EV) to a source of electricity to recharge a battery of an EV.

The terms “about” and “approximately”, as used herein when referring to a measurable value or number, is meant to encompass variations of ±10%, ±5%, ±1%, ±0.5%, or even ±0.1% of the specified value as well as the specified value. For example, “about X” where X is the measurable value or number, is meant to include X as well as variations of ±10%, ±5%, ±1%, ±0.5%, or even ±0.1% of X. A range provided herein for a measurable value or number may include any other range and/or individual value therein.

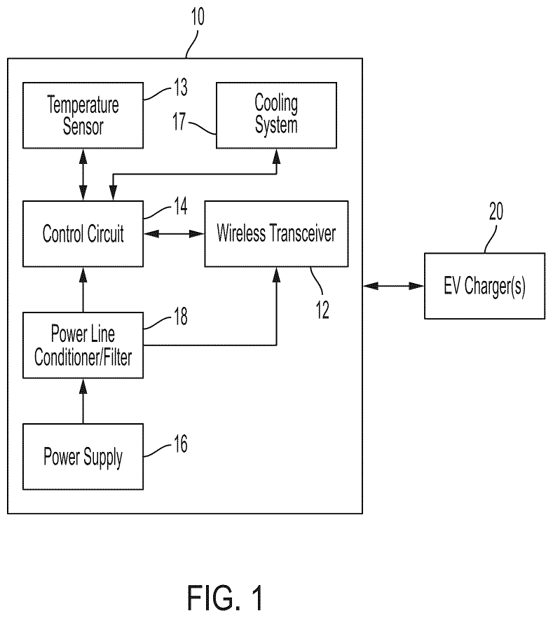

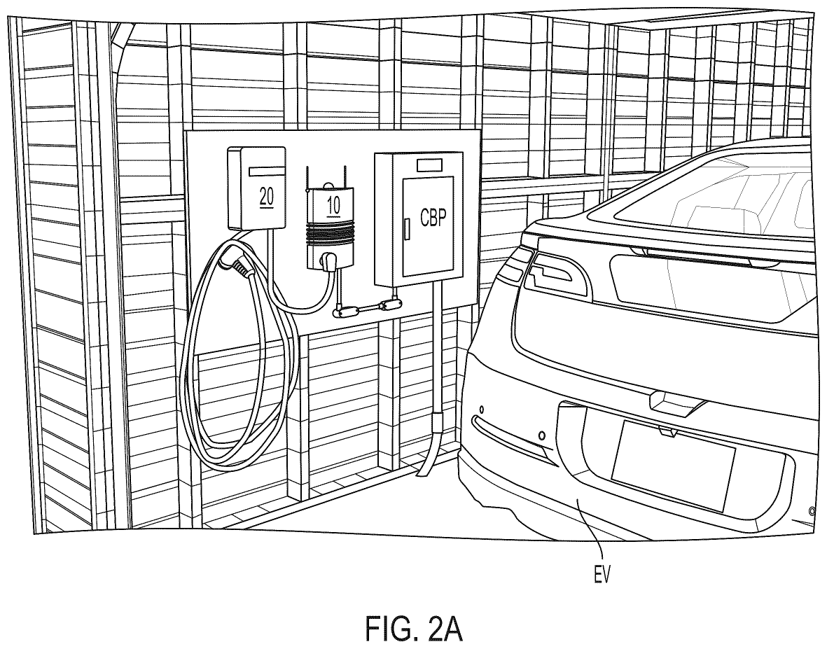

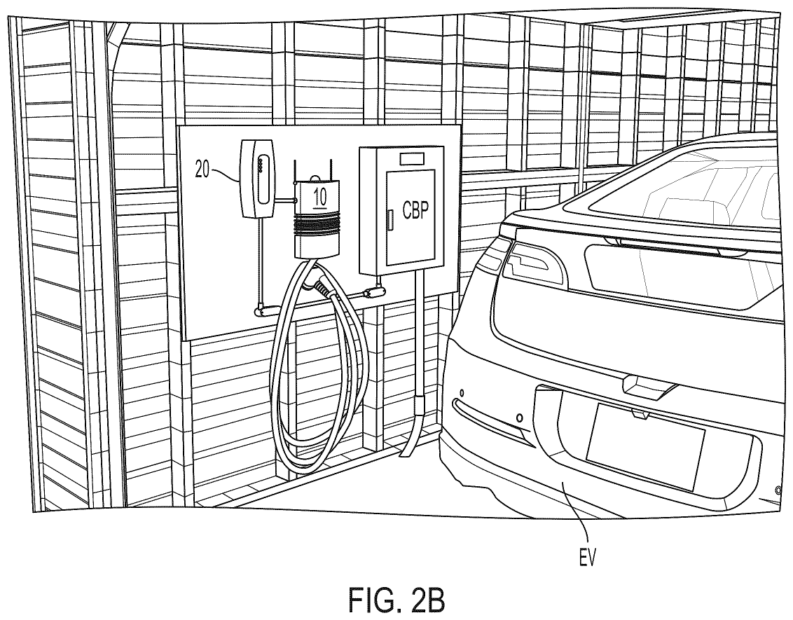

Referring to the figures, a Local Distributed Intelligence Node (LDIN) device 10 (FIG. 1) configured to monitor and control an EV charger 20 (FIGS. 2-4) during a charging session of an EV includes a wireless transceiver 12, a control circuit 14, an internal temperature sensor 13, a power supply 16, and a line conditioner/filter 18. As known to those of skill in the art of the present invention, the EV charger 20 converts AC current from an electric power grid into a constant DC current in order to charge a battery of an EV. The LDIN device 10 may be mounted near or within an EV charger 20. In FIGS. 2A, 2B and 3-7, each illustrated LDIN device 10 is mounted adjacent to an EV charger and the control circuit 14 may be hardwired to the input and output side of the EV charger 20. However, the LDIN device 10 may have the control circuit wirelessly connected to the input or output side of the EV charger 20 in other embodiments (FIGS. 2A and 2B, respectively). The arrow between the LDIN device 10 and the EV charger(s) 20 in FIG. 1 is intended to mean a direct connection between the LDIN device 10 and the EV charger(s) 20 and a wireless connection between the LDIN device 10 and the EV charger(s) 20. FIG. 2A shows the LDIN device 10 wired to the input side of a networked Level 2 EV charger 20, while FIG. 2B shows the LDIN device 10 wired to the output side of a non-networked Level 2 EV charger 20.

The power supply 16 may be, for example, an alternating current (AC) power supply receiving power from a customer premise (e.g., from a circuit breaker panel CBP illustrated in FIGS. 2A-2B) where an EV charger 20 is located. The power line conditioner/filter 18 is configured to stabilize incoming AC power to protect the transceiver 12 and the control circuit 14 by providing surge protection, preventing voltage fluctuations, removing electrical interference, etc.

The internal temperature sensor 13 measures the operating temperature of the LDIN device 10, and is connected to and powered by the control circuit 14. The performance of the LDIN device 10 can be hampered and/or degraded when operating at an excessively high temperature, as well as at an excessively low temperature, particularly for extended periods of time. Moreover, solar irradiance on an LDIN device can compound the operating temperature and raise the operating temperature to excessively high levels. When the temperature of the LDIN device 10, as measured by the temperature sensor 13, exceeds a threshold temperature, the control circuit 14 may throttle an EV charging session or may stop an EV charge session all together. For example, if the temperature of the LDIN device 10 is excessively high or is at an elevated temperature for a predetermined period of time, the control circuit 14 may terminate an EV charging session altogether. However, if the temperature of an LDIN device 10 exceeds a threshold, but not excessively, or is at an elevated temperature for only a short period of time, the control circuit 14 may just throttle an EV charging session until the LDIN device temperature falls back to an acceptable level or range. Similarly, if the temperature of an LDIN device 10 is excessively below a threshold temperature or is at a lower temperature for a predetermined period of time, the control circuit 14 may terminate an EV charging session altogether. However, if the temperature of an LDIN device 10 is below a threshold, but not excessively, or is at a lower than normal temperature for only a short period of time, the control circuit 14 may just throttle an EV charging session until the LDIN device temperature rises back to a normal level or range.

In some embodiments, the LDIN device 10 may be provided with a cooling system 17, such as one or more fans and/or a liquid cooling system. When the temperature of the LDIN device 10, as measured by the temperature sensor 13, exceeds a threshold temperature, the control circuit 14 may trigger active cooling via the cooling system 17 to cool the LDIN device 10 back to an optimal/preferred operating temperature. However, such a cooling system 17 is optional and an LDIN device 10 is not required to have a cooling system. LDIN devices in some embodiments may utilize passive cooling that relies on natural heat dissipation techniques such as conduction, convection, and radiation to manage the temperature of the electronic components therewithin.

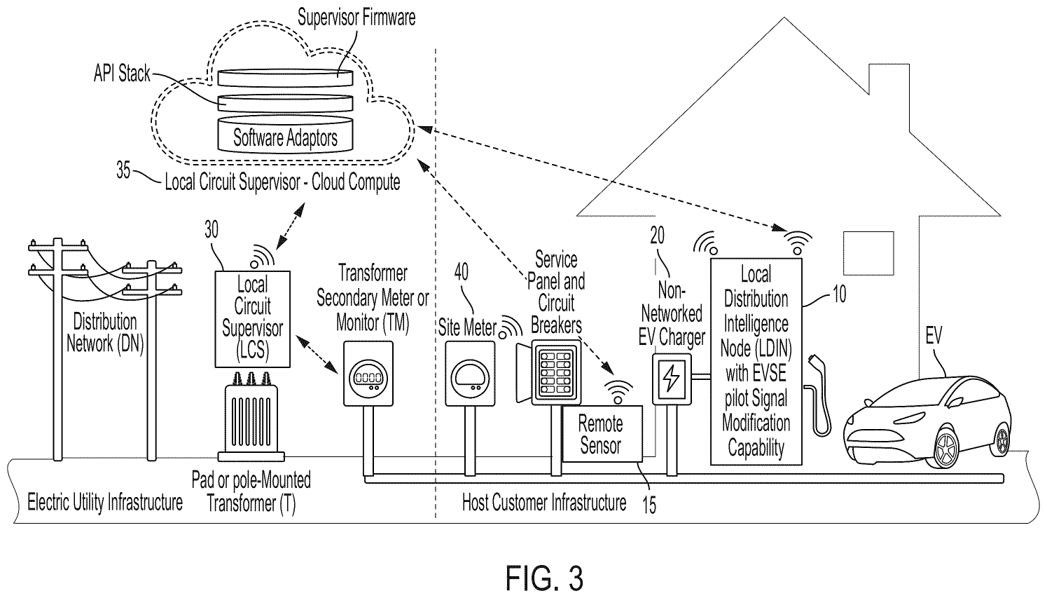

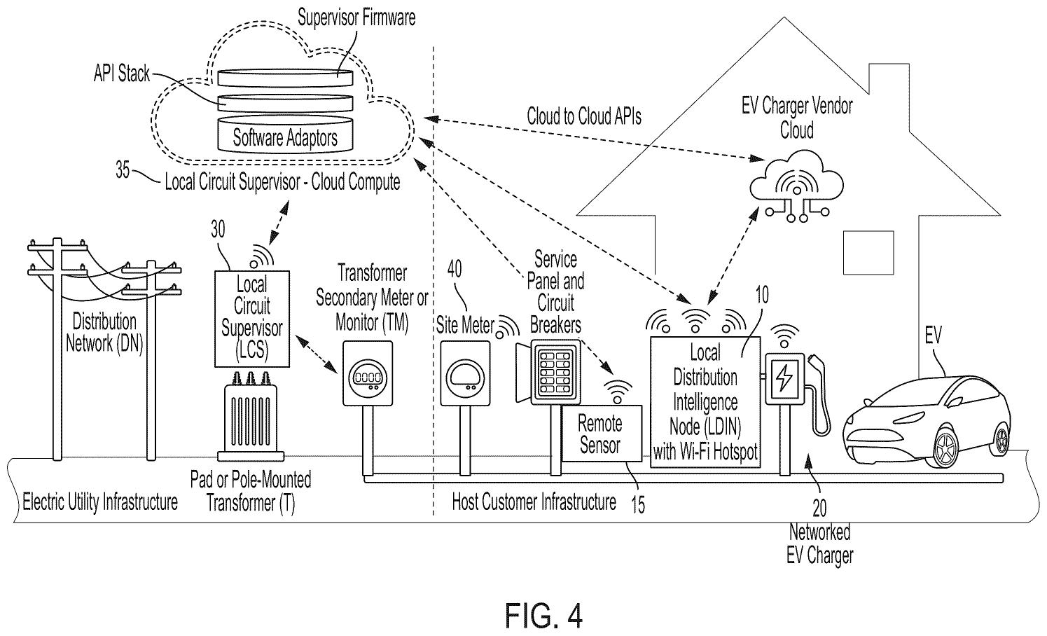

The control circuit 14 of the LDIN device 10 is configured to receive signals, via the transceiver 12, from a Local Circuit Supervisor (LCS) device 30 (FIGS. 3-7) that is associated with an electric power grid providing electric power to the EV charger 20. The LCS device 30 is the supervisor of all LDIN devices 10 within its feeder circuit and/or geographical area. Typically, the LCS device 30 is positioned on or near an electric utility transformer. For example, in the embodiments illustrated in FIGS. 3 and 4, the LCS device 30 is positioned on a pad-mounted or pole-mounted electric utility transformer T. The LDIN device 10 may communicate with an LCS device 30 on demand or at preset time intervals.

The LCS device 30 serves as the monitoring and control hub for all LDIN devices 10 within its feeder circuit and/or geographical area. The LCS device 30 monitors the electrical loading (e.g., current, output voltage, etc.) of an electric utility transformer T as well as the thermal loading of system components associated with a single or group of EV chargers such as circuit breakers, service panels, a distribution circuit or a transformer.

The control circuit 14 of the LDIN device 10 may be configured to throttle (i.e., increase or decrease) an amount of charge current supplied to the EV by the EV charger 20 in response to a signal from the LCS device 30. For example, if the signal from the LCS device 30 includes an indication of a potential overload condition of a transformer T on the electric power grid that is providing electric power to the EV charger 20, the LDIN device 10 is configured to reduce or throttle the amount of charge current being supplied to the EV by the EV charger, thereby reducing the load on the electric power grid.

As another example, if an LCS device 30 detects multiple users are charging EVs during a time of increased load on the electric power grid, the LCS device 30 can send out commands to an LDIN device 10 associated with each EV charger 20 to throttle the amount of charge current to one or more of the EV chargers 20 so as not to overload the electric power grid.

In some embodiments, the signal from the LCS device 30 may include an indication that thermal loading of one or more components associated with the EV charger 20 has exceeded a threshold value. Such components may include a circuit breaker, a service panel, a distribution circuit, a transformer, etc. Upon receiving a signal that thermal loading has exceeded a threshold value, the control circuit 14 is configured to reduce the amount of charge current supplied to the EV by the EV charger 20.

In some embodiments, the signal from the LCS device 30 may include an indication that the transformer T on the electric power grid that is providing electric power to the EV charger 20 is not overloaded. In this case, the control circuit 14 is configured to increase the amount of charge current supplied to the EV by the EV charger 20 or maintain the amount of charge current supplied to the EV by the EV charger 20 at the present amount.

In some embodiments, the signal from the circuit supervisor device 30 may include an indication that there is no thermal loading of one or more components associated with the EV charger 20, such as a circuit breaker, a service panel, a distribution circuit, a transformer. In this case, the control circuit 14 is configured to increase the amount of charge current supplied to the EV by the EV charger 20 or maintain the amount of charge current supplied to the EV by the EV charger at the present amount.

In some embodiments, when the electric power grid is experiencing increased demand from customers, the LCS device 30 may send a signal to the LDIN device 10 to stop a charging session. In addition, the LDIN device 10 is configured to cause the EV to discharge electric power into the electric power grid via the EV charger 20.

In some embodiments, such as shown in FIGS. 3 and 4, a system configuration may include one or more remote sensors 15 associated with and/or in communication with an LDIN device 10. For example, a remote sensor 15 may be provided that is configured to monitor (e.g., wirelessly monitor) one or more parameters associated with a feeder circuit providing electric power to the EV charger 20 from an electric power grid. Such parameters may be a power load on a transformer associated with the feeder circuit and/or thermal loading of one or more components associated with the feeder circuit, such as a circuit breaker, a service panel, a distribution circuit, a transformer, etc. The control circuit 14 may be configured to throttle an amount of charge current supplied to the EV battery by the EV charger 20 in response to the at least one parameter exceeding a threshold value or falling below a lower threshold value.

Another remote sensor 15 may be provided that is configured to monitor temperature and/or humidity in a vicinity of the feeder circuit supplying AC current to an EV charger 20 and transmit this information wirelessly to the control circuit 14 of an LDIN device 10. The control circuit 14 may be configured to throttle the amount of electric power received by the EV battery from the EV charger 20 in response to the temperature and/or humidity in the vicinity of the feeder line exceeding an upper threshold value or falling below a lower threshold value. Temperature and/or humidity exceeding an upper threshold value (e.g., during summer months, etc.) or falling below a lower threshold value (e.g., during winter months, etc.) may be an indication of excessive demand being placed on the electric power grid.

The control circuit 14 is configured to throttle the amount of charge current supplied to an EV by the EV charger 20 by utilizing and modifying the Control Pilot signal that is being transmitted between the EV charger 20 and the EV via the Control Pilot pin in the SAE J1772, SAE J3400 or other similarly compliant EV connector. The Control Pilot uses pulse width modulation to communicate charging state and maximum allowable charge current in accordance with IEC 61851. The control circuit can accept commands to modify the control current request from either the EV or the EV charger in compliance with the IEC 61851 standard.

The control circuit 14 is configured to report a real-time status of the EV charger 20 to the LCS device 30 via the transceiver 12. Examples of information that may be reported from the LDIN device 10 to the LCS device 30 or the LCS Cloud Compute platform 35 include charge session start and end times as well as kilowatt-hour (kWh) dispensed, instantaneous kilowatt (kW) or voltage, EV charger health and connection status as well as whether the EV charger has opted in or opted out to a demand response event (i.e., an event where load needs to be reduced on an electrical power grid or portion thereof).

The transceiver 12 of an LDIN device 10 may also be configured to communicate with an electric meter 40 associated with an EV charger 20 or a group of EV chargers 20. The control circuit 14 of the LDIN device 10 is configured to collect revenue grade data from the electric meter 40 via the transceiver 12. As such, this provides the ability to measure charge session energy usage for a single EV charger 20 or for multiple EV chargers 20 connected to the same electric meter with revenue-grade accuracy using the electric utility meter 40. The LDIN collects the revenue grade kW and kWh data from the electric meter for each charge session that it records. In some embodiments, such as shown in FIGS. 3 and 4, the LDIN device 10 communicates with an electric meter 40 using wireless or radio communication techniques.

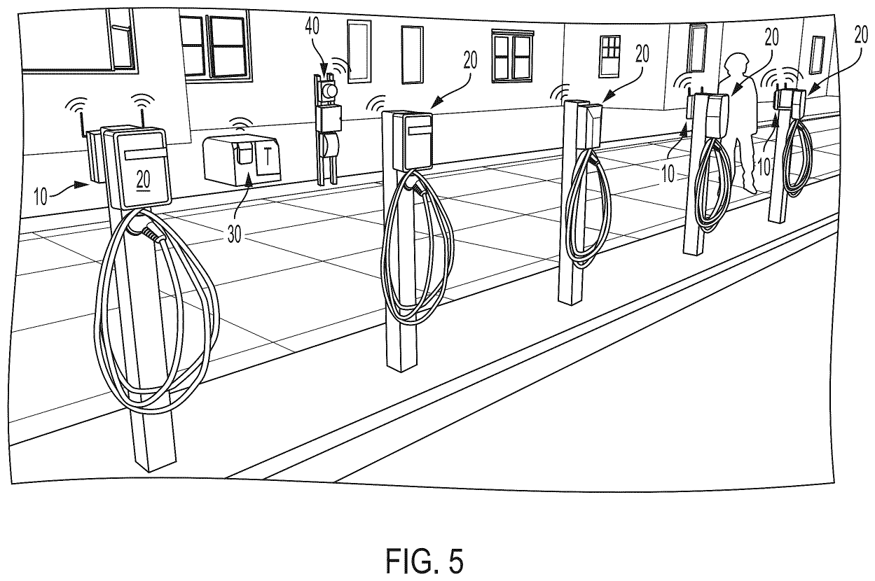

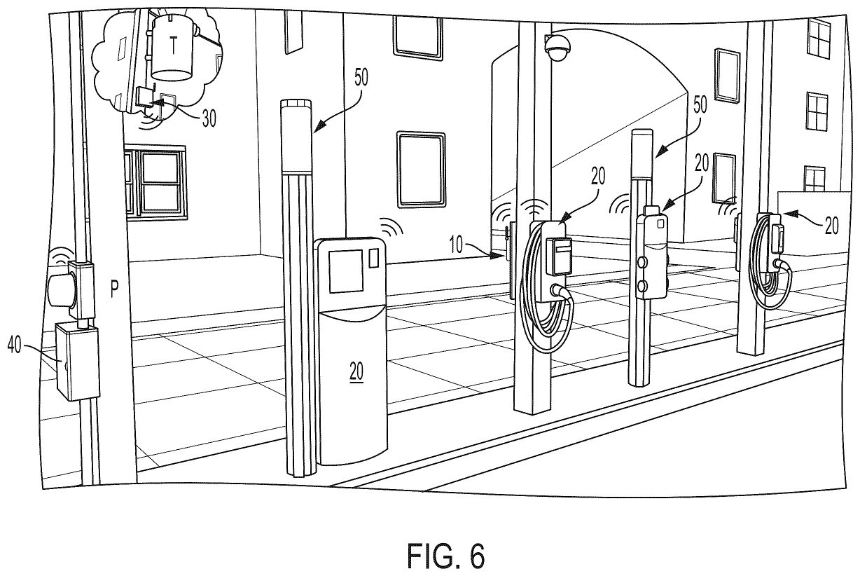

Referring to FIGS. 5 and 6, an LDIN device 10 may be configured to communicate with one or more additional EV chargers 20 in a vicinity of the LDIN device 10, as well as an LCS device 30 associated with the group of EV chargers 20. In FIG. 5, the LCS device 30 associated with the group of EV chargers 20 is positioned on a pad-mounted electric utility transformer T. In FIG. 6, the LCS device 30 associated with the group of EV chargers 20 is positioned adjacent an electric utility transformer T mounted on a pole P.

Each of the EV chargers 20 in FIGS. 5 and 6 are configured to wirelessly transmit information to an LCS device 30 or to the LCS Cloud Compute platform 35 (FIGS. 3 and 4). Each of the LDIN devices 10 associated with the illustrated group of EV chargers (in FIG. 5, one LDIN device 10 is associated with two of the illustrated EV chargers) can receive instructions (i.e., a signal) from the LCS device 30 or LCS Cloud Compute platform 35 and then throttle the amount of charge current supplied to one or more of the EV chargers 20 in response to the instructions. In addition, each LDIN device 10 can provide real-time or interval status of one or more EV chargers 20 to the LCS device 30 or the LCS Cloud Compute platform 35.

Referring back to FIGS. 3 and 4, there are two basic operating scenarios for an LDIN device 10. The first is where an LDIN device 10 is connected to a non-networked (or “dumb”) EV charger 20 on the output side of the charger 20 (FIG. 3), and the second is where the LDIN device 10 is connected to a networked EV charger 20 on the input side of the charger 20 (FIG. 4). In the second scenario (i.e., FIG. 4), the LDIN device 10 may serve up a Wi-Fi hotspot to allow one or more EV chargers 20 to connect to the internet and “phone home” to (i.e., communicate with) their native (i.e., the manufacturer's) cloud platform. In this case, the EV charger 20 can be monitored and controlled via an Application Programming Interface (API) between the LCS Cloud Compute platform 35 and the EV charger vendor's cloud.

Each LDIN device 10 may communicate with an electric meter 40 associated with the group of EV chargers 20 and obtain charge session energy usage data for one or more of the EV chargers 20.

The control circuit 10 of an LDIN device 10 according to some embodiments of the present invention, may be configured to control informational lighting on or near an EV charger 20 to indicate operational status or availability of the EV charger 20 for charging. For example, in FIG. 6, two of the illustrated EV chargers 20 have an informational light 50 positioned nearby. Each light 50 may be controlled by an LDIN device 10 to illuminate when the associated EV charger is available for use. For example, a green color emitted by the light 50 may indicate that the EV charger 20 is available for use. Alternatively, each light 50 may be controlled by an LDIN device 10 to illuminate when the associated EV charger is not available for use. For example, a red color emitted by the light 50 may indicate that the EV charger 20 is not available for use. In some embodiments, the light 50 may be controlled by an LDIN device 10 to indicate that the EV charger 20 associated therewith has been reserved by a third party for future charging. For example, a blue color emitted by the light 50 may indicate that the EV charger 20 is reserved by a third party. An orange color may be utilized to indicate a fault state of the EV charger 20.

Informational lighting (e.g., light 50 in FIG. 6, etc.) used in conjunction with an EV charger 20, according to embodiments of the present invention, is not limited to a specific color for a specific status of an EV charger 20. Various colors may be utilized without limitation. In some embodiments, the informational lighting used in conjunction with an EV charger 20 may be customized for particular events, holidays, etc. For example, informational lighting used in conjunction with EV chargers 20 may display the color(s) of a local professional sports team or local college sports team. The associated colors of the sports teams could indicate that associated EV chargers 20 are reserved for attendees or fans of a professional or college sports team event in the area.

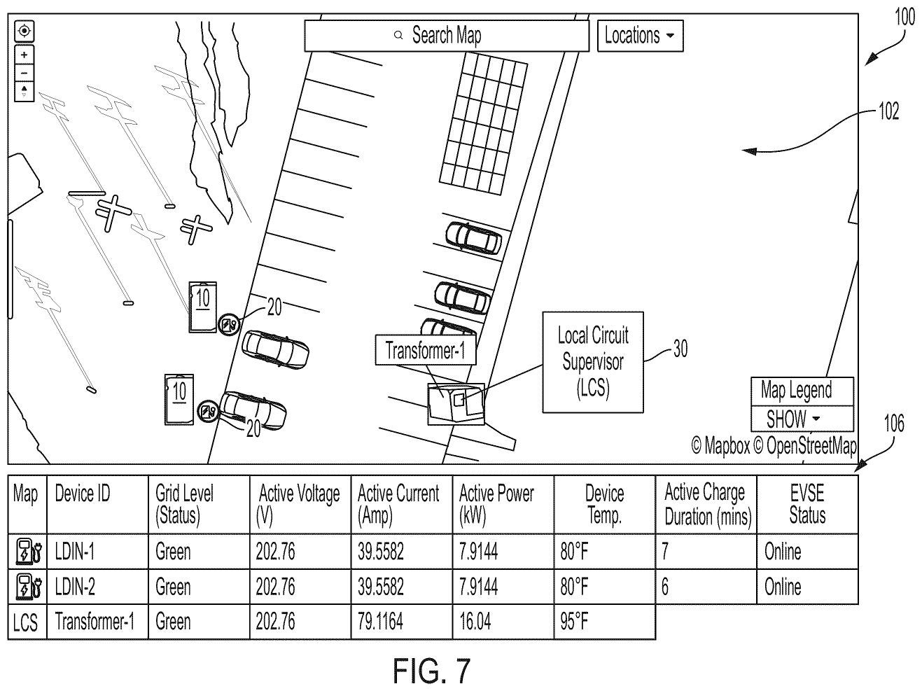

FIG. 7 illustrates a user interface 100 configured to be viewed by an EV charger owner, by a site host customer, or by operations and maintenance supervisory personnel and that displays information from one or more LDIN devices 10 associated with one or more EV chargers 20. A host customer is a customer that agrees to host one or multiple EV chargers 20 at their site, such as their residence or place of business. The illustrated user interface 100 displays identification and location information of two EV chargers 20 and two respective LDIN devices 10. The locations of the EV chargers 20 and LDIN devices 10 are displayed graphically on a map 102. Information about each EV charger 20 is displayed within the table 106 located below the map 102.

The illustrated information includes the LDIN device number associated with a particular EV charger 20, status or level of the electrical grid to which the EV chargers 20 are connected, active voltage data for each EV charger 20, active current data for each EV charger 20, active power data for each EV charger 20, active charge duration for each EV charger 20, the status of each EV charger (i.e., online or offline), and the operating temperature of each LDIN device 10. In addition, the table 106 also contains information about the LCS device 30 associated with the two EV chargers 20. The illustrated information includes an identification of the electrical grid transformer to which the EV chargers 20 are connected, status or level of the electrical grid to which the transformer is connected, active voltage data for the transformer, active current data for the transformer, active power data for the transformer, and the operating temperature of the transformer.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the teachings and advantages of this invention. Accordingly, all such modifications are intended to be included within the scope of this invention as defined in the claims. The invention is defined by the following claims, with equivalents of the claims to be included therein.

What is claimed is:

1. A device configured to monitor and control an electric vehicle (EV) charger during a charging session of an EV, the device comprising:
a wireless transceiver; and
a control circuit configured to receive a signal, via the transceiver, from a Local Circuit Supervisor (LCS) device associated with an electric power grid providing electric power to the EV charger, and to throttle an amount of charge current supplied to the EV by the EV charger in response to receiving the signal.

2. The device of claim 1, wherein the signal is an indication of a potential overload condition of a transformer on the electric power grid that is providing electric power to the EV charger, and wherein the amount of charge current supplied to the EV by the EV charger is reduced.

3. The device of claim 1, wherein the signal is an indication that thermal loading of one or more of the following components associated with the EV charger has exceeded a threshold value: a circuit breaker, a service panel, a distribution circuit, a transformer, and wherein the amount of charge current supplied to the EV by the EV charger is reduced.

4. The device of claim 1, wherein the signal is an indication that the transformer on the electric power grid that is providing electric power to the EV charger is not overloaded, and wherein the amount of charge current supplied to the EV by the EV charger is increased or maintained at a present constant amount.

5. The device of claim 1, wherein the signal is an indication that there is no thermal loading of one or more of the following components associated with the EV charger: a circuit breaker, a service panel, a distribution circuit, a transformer, and wherein the amount of charge current supplied to the EV by the EV charger is increased or maintained at a present constant amount.

6. The device of claim 1, wherein the control circuit is configured to throttle the amount of charge current supplied to the EV by communicating with a Pilot Control signal that is being transmitted between the EV charger and the EV via a communication line.

7. The device of claim 1, wherein the control circuit is hardwired to the EV charger.

8. The device of claim 1, wherein the control circuit is wirelessly connected to the EV charger.

9. The device of claim 1, wherein the control circuit is further configured to report a real-time status of the EV charger to the LCS device via the transceiver.

10. The device of claim 1, wherein the transceiver is further configured to communicate with an electric meter associated with the EV charger, and wherein the control circuit is configured to collect revenue grade data from the electric meter via the transceiver.

11. The device of claim 1, wherein the transceiver is further configured to receive information from one or more additional EV chargers in a vicinity of the device, and the control circuit is configured to report a real-time status of the one or more additional EV chargers to the LCS device via the transceiver.

12. The device of claim 1, wherein the control circuit is further configured to control informational lighting on or near the EV charger to indicate operational status and availability of the EV charger for charging.

13. The device of claim 1, wherein the control circuit is further configured to control informational lighting on or near the EV charger to indicate that the EV charger has been reserved by a third party for future charging.

14. The device of claim 1, further comprising a power supply, and a power conditioning and filtering device.

15. The device of claim 1, further comprising a temperature sensor, and wherein the control circuit is configured to throttle an amount of charge current supplied to the EV by the EV charger in response to a temperature of the LDIN device, as measured by the temperature sensor, exceeding a threshold temperature.

16. The device of claim 15, wherein the LDIN device further comprises a cooling system, and wherein the control circuit is further configured to activate the cooling system in response to the temperature of the LDIN device exceeding the threshold temperature.

17. The device of claim 1, further comprising a temperature sensor, and wherein the control circuit is configured to throttle an amount of charge current supplied to the EV by the EV charger in response to a temperature of the LDIN device, as measured by the temperature sensor, falling below a threshold temperature.

18. A device configured to monitor and control an electric vehicle (EV) charger during a charging session of an EV, the device comprising:
a wireless transceiver; and
a control circuit configured to receive a signal, via the transceiver, from a Local Circuit Supervisor (LCS) device associated with an electric power grid providing electric power to the EV charger, to stop the charging session, and to cause the EV to discharge electric power into the electric power grid via the EV charger in response to receiving the signal.

19. The device of claim 18, wherein the signal is an indication of a need for electric power by the electric power grid.

20. The device of claim 18, wherein the control circuit is hardwired to the EV charger.

21. The device of claim 18, wherein the control circuit is wirelessly connected to the EV charger.

22. The device of claim 18, wherein the control circuit is further configured to report a real-time status of the EV charger to the LCS device via the transceiver.

23. The device of claim 18, further comprising a power supply, and a power conditioning and filtering device.

24. A system configured to monitor and control an electric vehicle (EV) charger during a charging session of an EV, the system comprising:
a remote sensor that is configured to monitor at least one parameter associated with a feeder circuit providing electric power to the EV charger from an electric power grid; and
a device comprising a transceiver and a control circuit configured to receive a signal, via the transceiver, from the remote sensor, wherein the control circuit is configured to throttle an amount of charge current supplied to the EV by the EV charger in response to the at least one parameter exceeding an upper threshold value or falling below a lower threshold value.

25. The system of claim 24, wherein the at least one parameter comprises a power load on a transformer associated with the feeder circuit.

26. The system of claim 24, wherein the at least one parameter comprises thermal loading of one or more of the following components associated with the feeder circuit: a circuit breaker, a service panel, a distribution circuit, a transformer.

27. The system of claim 24 wherein the sensor is configured to wirelessly monitor the at least one parameter associated with the feeder circuit.

28. The system of claim 24, further comprising a second remote sensor that is configured to monitor temperature and/or humidity in a vicinity of the feeder circuit, and wherein the control circuit is further configured to throttle the amount of electric power received by the EV battery from the charger in response to the temperature and/or humidity in the vicinity of the feeder line exceeding an upper threshold value or falling below a lower threshold value.

29. The system of claim 24, wherein the transceiver is configured to communicate with a Local Circuit Supervisor (LCS) device associated with the electric power grid, and wherein the control circuit is further configured to receive commands from the LCS device via the transceiver, and to report a real-time status of the EV charger to the LCS device via the transceiver.

30. The system of claim 24, wherein the control circuit is further configured to stop the charging session and cause the EV to discharge electric power into the electric power grid via the EV charger in response to the at least one parameter.

31. The system of claim 24, wherein the control circuit is further configured to control informational lighting on or near the EV charger so as to indicate one or more of the following: operational status of the EV charger, availability of the EV charger, a fault condition of the EV charger, whether the EV charger has been reserved by a third party for future charging.

32. The system of claim 24, wherein the device further comprises a temperature sensor, and wherein the control circuit is configured to throttle an amount of charge current supplied to the EV by the EV charger in response to a temperature of the device, as measured by the temperature sensor, exceeding a threshold temperature.

33. The system of claim 32, wherein the device further comprises a cooling system, and wherein the control circuit is further configured to activate the cooling system in response to the temperature of the device exceeding the threshold temperature.

34. The system of claim 24, further comprising a temperature sensor, and wherein the control circuit is configured to throttle an amount of charge current supplied to the EV by the EV charger in response to a temperature of the device, as measured by the temperature sensor, falling below a threshold temperature.
